(19) United States
(12) Patent Application Publication
(10) Pub. No.: US 2021/0156189 A1
(43) Pub. Date: May 27, 2021

(54) Retrofit Door Frame System

(71) Applicant: Omer Barnes, Harrington Park, NJ (US)

(72) Inventor: Omer Barnes, Harrington Park, NJ (US)

(21) Appl. No.: 17/105,775

(22) Filed: Nov. 27, 2020

Related U.S. Application Data
(60) Provisional application No. 62/940,675, filed on Nov. 26, 2019.

(51) Int. Cl. E06B 1/52; E06B 1/18; E06B 1/60; E06B 3/988

(52) U.S. Cl. CPC E06B 1/52; E06B 3/9885; E06B 1/6015; E06B 1/18

(57) ABSTRACT

A frame system for retrofitting a door frame system to secure a cooperating security door. The frame is formed of two opposing frame units that are installed over a pre-existing door frame from to opposing sides. The frame units are sized such that one fits within the other and partially overlap where the two units meet. A cooperating security door is hung from one of the frame units.

### RELATED APPLICATIONS

This application claims the benefit of pending U.S. Prov. Appl. 62/940,675 filed Nov. 26, 2020, the contents of which are fully incorporated by reference herein.

### FIELD OF THE INVENTION

The invention relates to the field of security doors, more specifically to a system for retrofitting existing doorways for purpose of installing security doors.

### BACKGROUND OF THE INVENTION

Incidents of mass shootings have, unfortunately, been on the rise across the United States. In response, schools and other public institutions have invested in physical security enhancements and they have instituted safety plans, such as lock down procedures, to enhance preparedness for a live shooting event.

### SUMMARY OF THE INVENTION

Embodiments of the invention provide a frame system and a cooperating security door, whereby the frame system is configured to retrofit existing door frames. The retrofitting frame system and cooperating security door allows institutions, such as schools or businesses, to easily retrofit existing door frames with door frames that are designed to support a security door.

### BRIEF DESCRIPTION OF THE DRAWINGS

FIG. 1 are respective exploded views of two cooperating door frame units according to an embodiment of the invention.

FIG. 2 is an enlarged partial view of the mating corners of door frame members of a first door frame in accordance with an embodiment of the invention.

FIG. 3 is a front perspective view of the frame members of FIG. 2 assembled according to an embodiment of the invention.

FIG. 4 is a side perspective view of the frame members of FIG. 2 assembled according to an embodiment of the invention.

FIG. 5 is an enlarged partial view of the mating corners of door frame members of a second door frame unit in accordance with an embodiment of the invention.

FIG. 6 is a front perspective view of the frame members of FIG. 5 assembled according to an embodiment of the invention.

FIG. 7 is a side perspective view of the frame members of FIG. 5 assembled according to an embodiment of the invention.

FIG. 8 is a side perspective view of a doorway having a first frame unit of an embodiment of the invention previously installed and a second frame unit of an embodiment of the invention positioned to be installed in accordance with embodiments of the invention.

FIG. 9 is a side perspective view of the doorway of FIG. 8 where the second door frame unit is installed over the first door frame unit in accordance with an embodiment of the invention.

FIG. 10 is a front view of a door installed on the door frame assembled in accordance with exemplary embodiments of the invention.

FIG. 11 is a schematic top cross-sectional view of an existing door frame having frame units in accordance with embodiments of the invention installed over the existing door frame.

FIG. 12 is a schematic top cross-sectional view of a door in accordance with embodiments of the invention shown disposed between door frames of embodiments of the invention.

### DETAILED DESCRIPTION OF THE INVENTION

Embodiments of the present invention will now be described with reference to the above-identified figures. However, the drawings and the description herein of the invention are not intended to limit the scope of the invention. It will be understood that various modifications of the present description of the invention are possible without departing from the spirit of the invention. Also, features or steps described herein may be omitted, additional steps or features may be included, and/or features or steps described herein may be combined in a manner different from the specific combinations recited herein without departing from the spirit of the invention, all as understood by those of skill in the art.

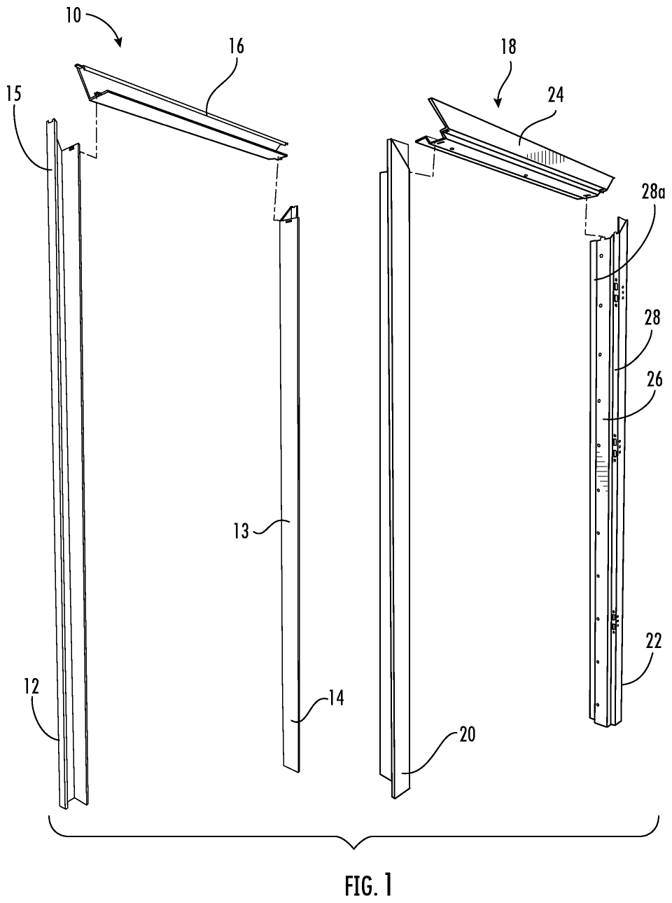

FIG. 1 shows exploded views of two cooperating frame assemblies in accordance with an embodiment of the invention. For example, a first frame assembly 10 (alternatively, a “frame unit”) is shown having a left vertical frame member 12, a right vertical frame member 14, and an upper horizontal frame member 16. Left and right vertical members 12, 14 have flat door-facing sections (e.g. 13) that are configured to align substantially parallel to the vertical beams framing a doorway. Vertical members 12, 14 also have front facing sections 15 disposed at substantial right angles to the door-facing sections 13. Sections 15 are configured to align with a wall and face forward (e.g. face the room/hallway etc.). As shown, horizontal member 16 is configured to bridge left and right vertical members 12, 14.

FIG. 1 also shows an exploded view of a second frame assembly 18. As shown, second frame assembly 18 is formed of a left vertical frame member 20, a right vertical member 22 and an upper horizontal member 24. Left and right vertical frame members 20, 22 have door-facing segments which include door stops 26 and door jambs 28 integrally formed. In embodiments of the invention a door stop 28 is a stepped up strip between a front door jamb 28 and a rear door jamb 28a. As shown, an upper horizontal member 24 is configured to bridge left and right vertical frame members, 20, 22.

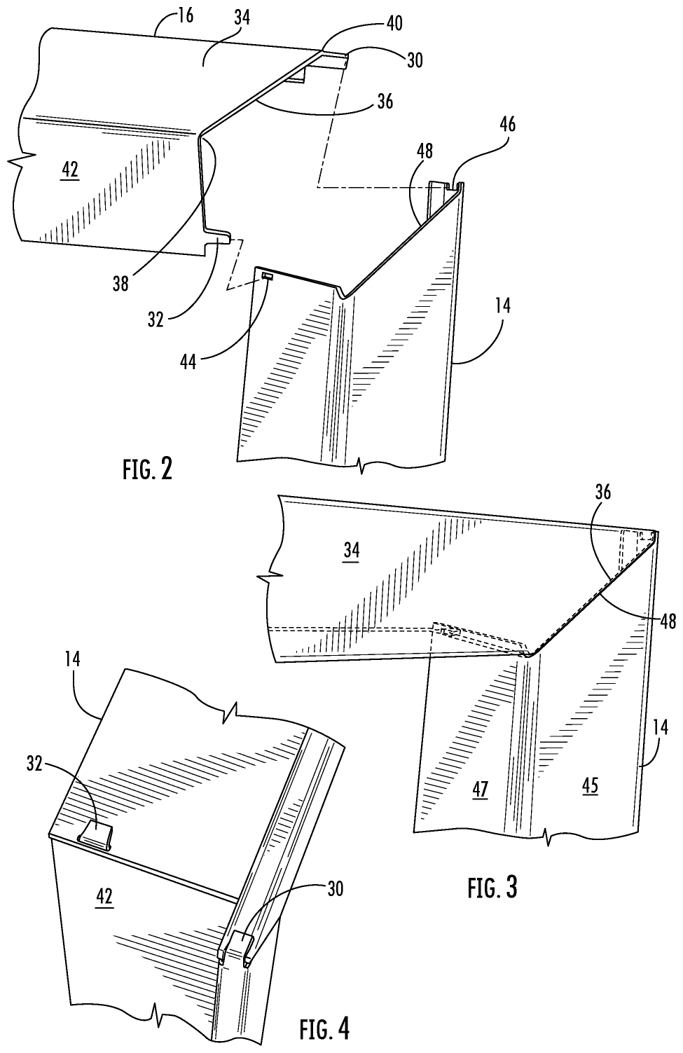

FIGS. 2-4 show stepwise views illustrating the formation of the first frame assembly 10 in accordance with an embodiment of the invention. To illustrate the exemplary construction of frame assembly 10, FIG. 2, which shows an enlarged partial view of a right edge of horizontal member 16, and an enlarged partial view of an upper segment of right vertical member 14 of frame assembly 10. As shown, horizontal member 16 has a front-facing surface 34 (e.g. positioned orthogonal to floor when installed) and a downward-facing surface 42 (e.g. substantially parallel to the floor when installed). Right and left edges of front facing surface 34 of member 16 terminate in respective angled edges. For example, the right end of horizontal member 16 is shown having an approximately 45° wall 36 (e.g. from corner 38 to top edge 40). It will be understood that front-facing surface 34 is disposed at a substantially 90° angle with respect to downward-facing surface 42.

Right vertical frame member 14 is similarly formed of a first (front-facing) frame section 45 disposed at a substantial right angle to a second (door-facing) frame section 47. When installed, first frame section 45 faces forward (e.g. faces the room), whereas the second frame section 47 is substantially parallel to the vertical beams supporting the door frame. The top of front-facing section 45 terminates in an approximately 45° angled edge 48. Angled edge 48 of first frame section 45 is complimentary to angled edge 36 of horizontal member 16 such that they fit together to form a right angle between horizontal member 16 and right vertical member 14.

As shown, in embodiments of the invention, an upper tab 30 extends from an upper frame section for horizontal member 16 and a lower tab 32 extends from a lower segment of the horizontal member 16. Lower tab 32 is sized and shaped to insert through a cooperating slot 44 in right vertical frame member 14, and upper tab 30 is configured to insert into notch 46 in right vertical frame member 14. Once respective tabs 32, 30 are inserted into slot 44 and notch 46, a hammer is used to strike the tabs 32, 30 in order to deform them such that they bend in order to grip and secure the horizontal member 16 to the right vertical frame member 14. Once assembled, and as shown in FIG. 3, front-facing surface 34 of horizontal frame member 16 forms a substantially contiguous plane with front-facing section 45 of right vertical frame member 14, whereas downward facing surface 42 of horizontal member 16 contacts door-facing frame section 47 of vertical frame member at a substantial right angle. FIG. 4 shows frame members 16, 14 attached view tabs 30, 32.

It will be understood that a left side of horizontal member 16 structurally mirrors the right edge thereof and is attached to left frame member 12 in a similar fashion as set forth above. Thus, it will be understood that foregoing description of the assembly of the right side of second frame unit 10 applies, in mirror, to the left side (e.g. connection of left vertical frame member 12 to horizontal frame member 16). Once assembled, the first door frame assembly 10 is installable as a unit.

FIGS. 5-8 show stepwise views illustrating the assembly of the second frame unit 18 in accordance with an embodiment of the invention. FIG. 5 shows an enlarged partial view of a right edge of horizontal frame member 24. Also shown is an upper segment of a right vertical frame member 22. As shown, a front-facing surface (e.g. facing a room once installed) 21 of vertical member 24 terminates in an approximately 45° edge 29. Right side of horizontal frame member 24 terminates in a cooperating 45° edge 25. In exemplary embodiments of the invention, a stepped down stabilizing tab 49 extends upward past angled edge 29 of vertical frame member 22.

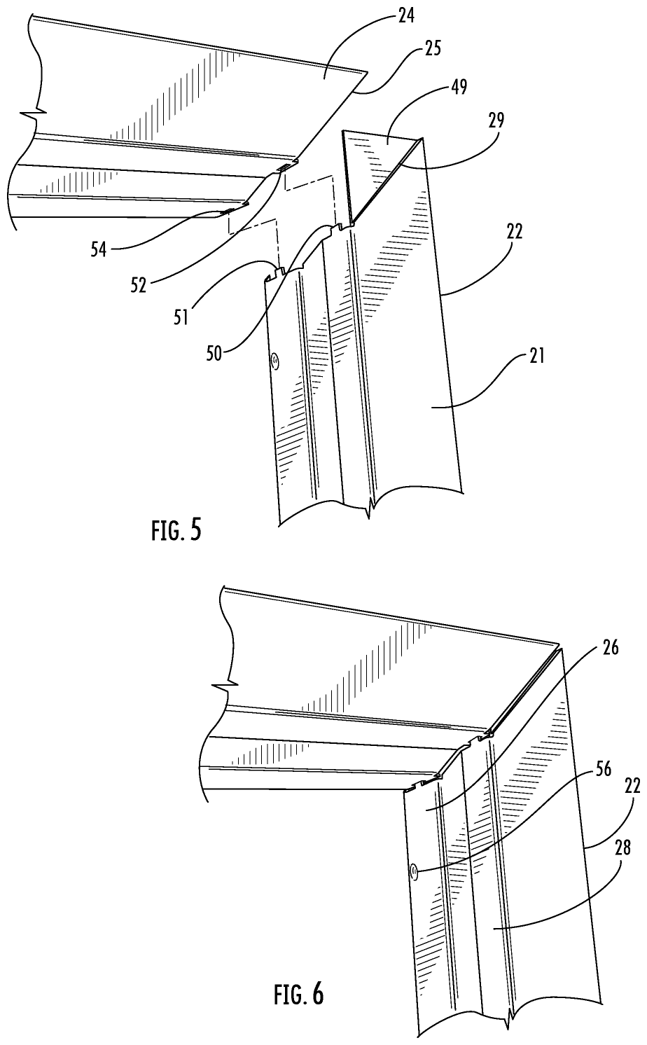

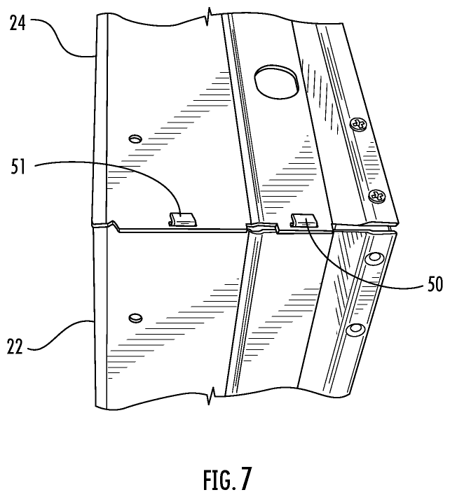

With continued reference to FIG. 5, in embodiments of the invention, an upper tab 50 extends from an upper frame section of vertical frame member 22 and a lower tab 51 extends from a lower segment of vertical frame member. Corresponding slots 52, 54 are provided on a floor-facing surface of horizontal member 24. As shown in FIG. 6, tabs 50, 51 are inserted through slots 52, 54, and as shown in FIG. 7, tabs 50, 51 are hammered down to bend tabs 50, 51 in a manner whereby they grip and secure horizontal member 24 to vertical member 22.

It will be understood that a left side of horizontal member 24 structurally mirrors the right edge thereof and is attached to left frame member 20 in a similar fashion as set forth above. Thus, it will be understood that foregoing description of the assembly of the right side of second frame unit 18 applies, in mirror, to the left side (e.g. connection of left vertical frame member 20 to horizontal frame member 24). Once assembled, the second door frame assembly 18 is installable as a unit.

In order to install a security door in accordance with embodiments of the invention, a user first forms the first frame assembly 10 by aligning the left and right vertical frame members 12, 14 with horizontal member 16 and inserting the tabs on the horizontal frame member into respective mating slots in vertical member as described. The user then taps the tabs with a hammer with enough force to fold the tabs down and grip the respective vertical frame members 12, 14. The second frame assembly 18 is similarly assembled.

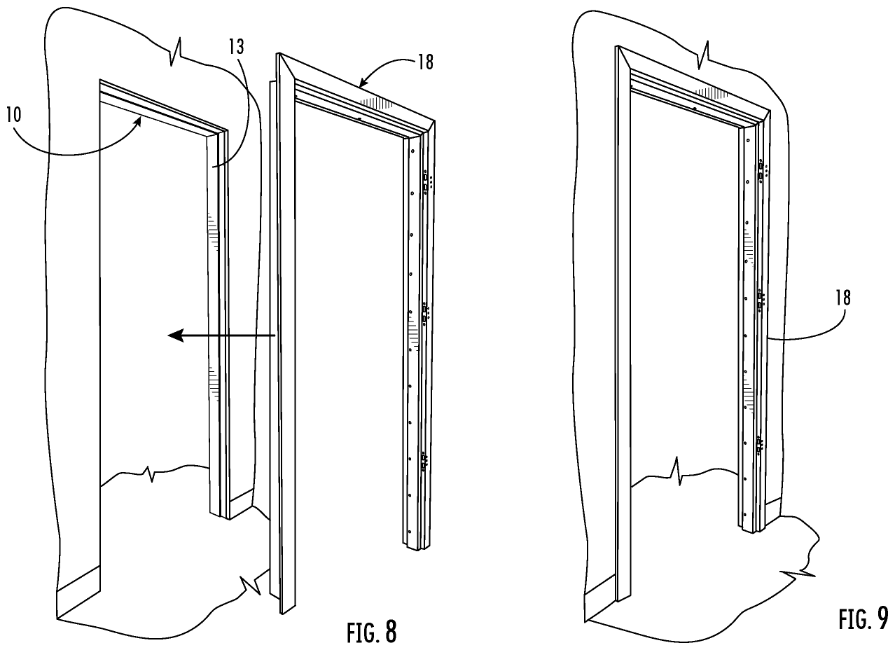

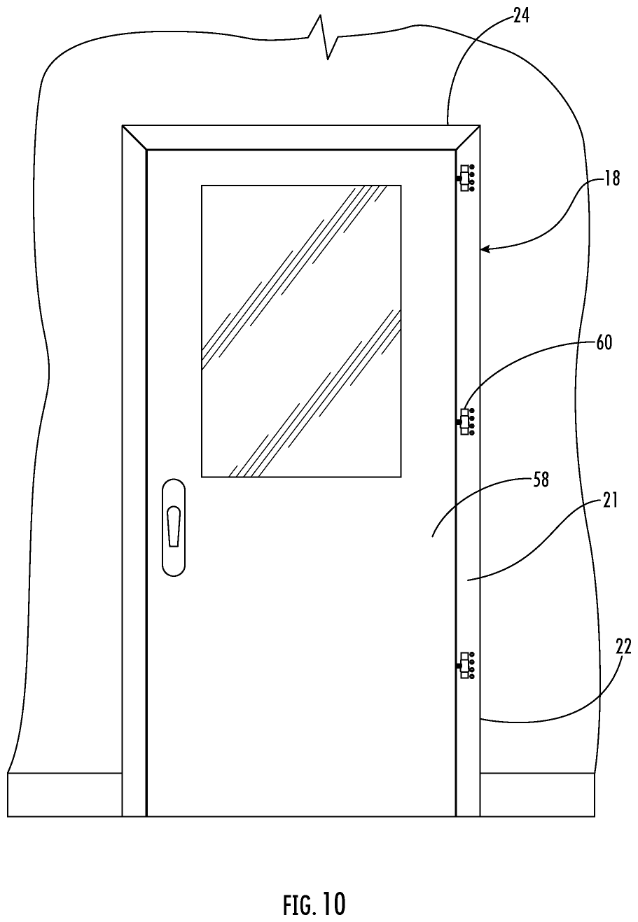

With reference to FIG. 8, a user then installs the first frame assembly 10 into an opening sized for a door or over an existing door frame. A user then installs the second frame assembly 18 from an opposite side of the doorway, whereby the second door frame assembly 18 overlaps at least partially with first door frame assembly 10. It will be understood that the assembled width of second door frame assembly 18 is smaller than the width of first door frame assembly 10. For example, a space defined by the distance between door facing sections of respective vertical frame members 12, 14, is greater than a distance between undersides of door facing sections of vertical frame members 20, 22. In this manner, second door frame assembly fits within first door frame assembly 10. Once installed, underside surfaces of portions of door jambs 28 of second frame assembly 18 contact door facing sections 13 of first frame assembly 10 and at least partially overlay portions of door-facing sections 13 of vertical frame members 12, 14. A user then inserts screws through any of various screw holes 56 in vertical frame members 20, 22. Screws so inserted secure second frame assembly 18 to the first assembly 10 and additionally secures the cooperating assemblies 10, 18 to the supporting beams.

Respective horizontal frame members 16, 24 are joined in a similar manner. For example, horizontal frame member 16 is installed first (e.g. as part of first frame assembly 10). Horizontal frame member 24 is installed as part of second frame assembly 18 such that a segment of downward-facing portion of horizontal frame member 24 overlaps with downward-facing surface 42 of horizontal frame member 16.

It will be understood that in embodiments of the invention, only vertical frame members 20, 22 are provided with screw holes and vertical frame members 12, 14 are not provided with screw holes. Similarly, a downward-facing surface of horizontal member 24 is provided with screw holes, whereas the downward-facing surface of horizontal member 16 is not provided with screw holes. In this manner, second frame assembly 18 may be applied over first frame assembly 10 at any of different amounts of overlap (depending on doorway thickness). Once applied, screws are placed in screw holes and driven through vertical frame members 20, 22 and horizontal frame member 24. Screws traverse into corresponding overlapping areas of vertical frame members 12, 14, and horizontal frame member 16, and insert into a pre-existing doorframe or other framed doorway opening (e.g. formed of walls or beams).

It will be understood that the cooperating frame assemblies 10, 18 allow the frames to be utilized to accommodate doorways of varying thicknesses. In this regard, the size of the fully assembled frame structure is adjustable by varying the amount of overlap between the first and second frame assemblies 10, 18.

FIG. 9 shows a doorway whereby respective first and second frame assemblies 10, 18 are installed. As shown, door facing sections 13 and door jamb/stop 26, 28 of respective first and second frame assemblies form the inner door frame. Front-facing sections of the respective frame members form surrounding encasement frames.

With reference to FIG. 10, subsequent to installing and securing the respective frame assemblies 10, 18, hinges 60 are secured to the front-facing surface 21 of vertical frame member 22 of second frame unit 18. A security door 58 is shown hingedly connected to the frame 18. Security door 58 may be a ballistic door, a fire resistant door or a similar reinforced door.

It will be understood that the materials used for the frame assemblies may any of various metals or metal alloys, including, steel, iron, aluminum or combinations thereof.

Embodiments of the invention allow for the convenient retrofitting of pre-existing door frames without the need to remove the pre-existing door frames. This cuts costs and ultimately allows public buildings and institutions such as schools to retrofit doors (e.g. classroom doors) with minimal construction cost.

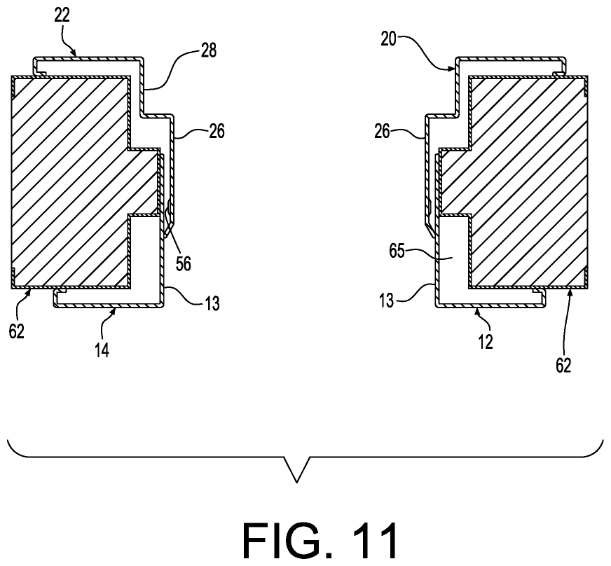

For example, FIG. 11, shows a schematic top cross-sectional view of frame units installed over a pre-existing door frame 62, thus obviating the need to demolish door frame 62. As shown, first frame assembly (e.g. vertical frame members 12, 14) is installed over frame 62. Second frame assembly (e.g. vertical frame members 20, 22) is installed overlapping the first frame assembly (e.g. a segment of left vertical frame member 20 overlaps with a segment of door-facing section 13 of left vertical frame member 12; and a segment of right vertical frame member 22 overlaps with a segment of door-facing section 13 of right vertical frame member 14).

As shown, an underside of door-facing section 13 of vertical frame member (e.g. 12) is placed over and substantially parallel to a door stop section of the pre-existing frame, creating a gap (e.g. 65) between vertical frame members 12, 20 and the pre-existing door frame 62. In this regard, the door frame as installed in accordance with embodiments of the invention creates a narrower opening than that of the pre-existing door frame. For example, the distance between door stops 26 of respective vertical frame segments 20, 22 is smaller than the distance between the door stops of the pre-existing door frame.

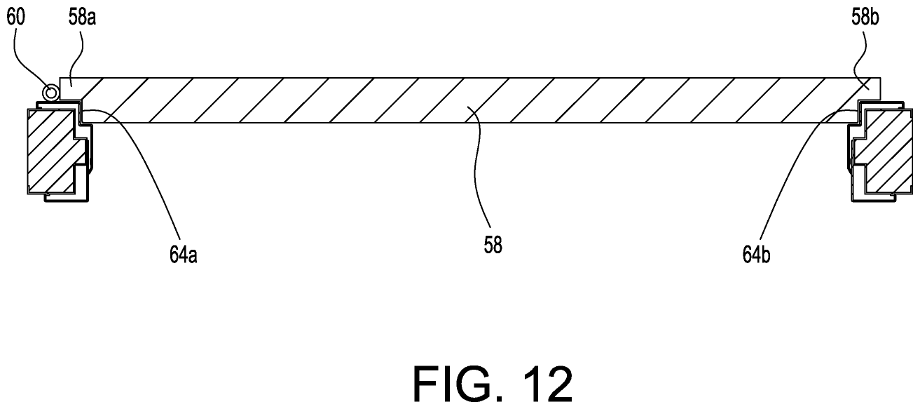

In embodiments of the invention, the diminishment in distance between door frames caused by the addition of the frame assemblies of the invention is made up by the configuration of the door used in embodiments of the invention. For example, referring to FIG. 12 it is shown that door 58 (shown in top cross-section view) is a panel having a main body having segments that extend laterally. For example, as shown, a first extending segment 58a extends from a first side of the door 58 and a second extending segment 58b extends from a second side of the door. Undersides of extending segments 58a, 28b form respective steps 64a, 64b at the point at which the extending segment extend laterally from the main body of the door. Steps 64a, 64b substantially align with respective door jambs of vertical frame member 20, 22. As shown, respective extending segments 64a, 64b substantially align with front facing segments of vertical frame members 20, 22. In embodiments of the invention, hinges (e.g. 60) are connected to one of the extending segments (e.g. 58a) which connect the door 58 to a segment of the second frame unit 18. Because extending segments 58a, 58b need not fit within the door frame, rather only the door segment spanning a distance between 64a and 64b must fit within the frame, the completed door frame formed in accordance with embodiments of the invention may be have a narrower opening (i.e. have a smaller distance between vertical frame members) than a pre-existing door frame upon which the frame units of the invention are placed.

Security doors used in connection with embodiments of the invention may be provided with twelve point locking such that when the lock is engages—a plurality of bolts extend from three the sides and top of the door and insert into cooperating channels in the door frame. In embodiments of the invention, doors are provided with a single action lock multi lock mechanism, whereby when the lock is engaged all locking points extend into the frame. For safety purposes (for example in the event of fire), all locking points are automatically withdrawn when a user rotates the doorknob to open the door.

Having described this invention with regard to specific embodiments, it is to be understood that the description is not meant as a limitation since further modifications and variations may be apparent or may suggest themselves to those skilled in the art. It is intended that the present application cover all such modifications and variations.

What is claimed is:

1) A door frame system, comprising:
a first frame assembly comprising a first vertical frame member comprising a door facing section, a second vertical frame member comprising a door facing section, and a first horizontal frame member configured to bridge the first vertical member and the second vertical frame member;
a second frame assembly comprising a third vertical frame member having a door facing section, a fourth vertical frame member having a door facing section, and a second horizontal member configured to bridge the third vertical member and the fourth vertical member;
the first assembly configured to be inserted into a doorway opening from a first side of the doorway opening;
the second assembly configured to be inserted in the doorway opening from an opposite side of the doorway opening, whereby at least a portion of the second assembly overlaps with a portion of the first assembly.

2) The door frame system of claim 1, whereby the door facing section of the first vertical frame member and door facing section of the second vertical frame member comprises a substantially flat surface.

3) The door frame system of claim 2, whereby the door facing section of the third vertical frame member and door facing section of the fourth vertical frame member comprises a door stop and a door jamb.

4) The door frame system of claim 3, whereby the third vertical frame member and the fourth vertical frame member comprise screw holes.

5) The door frame system of claim 1, whereby the first frame assembly comprises a first width defined by the space between respective door facing sections of the first and second vertical members.

6) The door frame system of claim 5, whereby the second frame assembly comprises a second width defined by the space between respective door facing sections of the third and fourth vertical members, whereby the second width is smaller than the first width.
